(19) United States
(12) Patent Application Publication
(10) Pub. No.: US 2008/0003892 A1
(43) Pub. Date: Jan. 3, 2008

(54) Printed circuit board and method for manufacturing a solderless electrical connection

(76) Inventors: Reinhard Fassel, Buechenbach (DE); Thomas Goettel, Buch Am Wald (DE); Harald Hejna, Leutershausen (DE)

Correspondence Address: KENYON & KENYON LLP, ONE BROADWAY, NEW YORK, NY, 10004, US

(21) Appl. No.: 11/818,639

(22) Filed: Jun. 15, 2007

(30) Foreign Application Priority Data
Jun. 16, 2006 (DE) 10 2006 027 748.1

(51) Int. Cl. H01R 13/42

(52) U.S. Cl. 439/751

(57) ABSTRACT

A printed circuit board having a plurality of press-fit sockets for accommodating press-fit pins, which are insertable from the direction of a broadside of the printed circuit board with press-fit into through holes of the press-fit sockets. The method includes applying, on a section of the broadside of the printed circuit board, of an insulating protective layer, which has passage holes for the press-fit pins situated above the through holes of the press-fit sockets.

### FIELD OF THE INVENTION

The present invention relates to a printed circuit board having a plurality of press-fit sockets for accommodating press-fit pins, as well as a method for manufacturing a solderless electrical connection between a printed circuit board fitted with press-fit sockets and a component fitted. with press-fit pins.

### BACKGROUND INFORMATION

Wherever a safe and reliable functioning of controls is especially important in automotive engineering, such as, for example, in the case of electronic controls of airbags and other restraint devices, of controls of automatic braking systems (ABS) or devices for vehicle dynamics control (ESL) as well as engine and transmission controls, press-fit connections are increasingly used for producing high-quality electrical contacts between a printed circuit board and an electronic component mounted on the printed circuit board, in which two or more parallel rows of protruding press-fit pins. of a multipoint plug integrated into the housing of the component are pressed with press-fit into complementary metallic press-fit sockets in the printed circuit board. These press-fit connections are very corrosion-resistant, have a constantly low transmission resistance over the service life of the motor vehicle and are additionally elastic such that interruptions or contact failures as a result of mechanical or thermal loads in the operation of the motor vehicle, such as frequently occur due to the formation of cracks in solder connections, can be avoided.

While in the manufacture of solder connections between solder pins of electronic components and through contacts of a printed circuit board it is possible to provide for the installation of a centering plate for centering and fixing the solder pins on the side of the printed circuit board in relation to the through contacts of the printed circuit board, this is not possible in the case of press-fit connections since there the space between the component and the broadside of the printed circuit board adjacent to the component must be kept free for a press-fit shoulder of the component as well as for the tool for producing the press-fit connection.

As a result, in press-fit connections, exceeding admissible pin position tolerances in a plane that is parallel to the broadside of the printed circuit board may have the result that individual press-fit pins enter the through hole of the associated press-fit socket of the printed circuit board either at a lateral offset or not at all, which can cause damage to the copper coating of a soldering land of the press-fit socket surrounding the component-side port of the through hole, to a cylindrical jacket of the press-fit socket penetrating the printed circuit board and acting as the through contact, to a circuit trace attached to the soldering land on the broadside of the printed circuit board adjacent to the component or to the press-fit pin itself by lateral bending. Furthermore, material may be removed on the press-fit pin and/or on the press-fit socket in the form of shavings or spangles, which under unfavorable circumstances may result in short circuits at other locations on the printed circuit board and thus in a functional failure.

In order to prevent an installation of finished printed circuit boards that have such defects, following the manufacture of the press-fit connection, the printed circuit boards must therefore also be subjected to a visual inspection in addition to an electrical contact test in order to sort out as rejects printed circuit boards having damaged connections or bent press-fit pins since the contact test is indeed able to detect a bent press-fit pin that is not in electrical contact with the soldering land of the press-fit socket, but not one that rests loosely on the soldering land, which in later operation may likewise result in failures.

### SUMMARY OF THE INVENTION

Taking this as its starting point, the exemplary embodiment and/or exemplary method of the present invention is based on the objective of improving a printed circuit board and a method of the type mentioned at the outset to the effect that the rejects are reduced and/or the requirement on the positional tolerances of the press-fit pins can be reduced, and that a loose contact between an unintentionally bent press-fit pin and a soldering land of the associated press-fit socket may be reliably prevented or detected without an additional visual inspection.

To achieve this objective, the exemplary embodiment and/or exemplary method of the present invention provides to fit the printed circuit board, prior to pressing the press-fit pins into the press-fit sockets, on a section of its broadside adjoining the component with an insulating protective layer, which has passage holes for the press-fit pins situated above the through holes of the press-fit socket.

The exemplary embodiment and/or exemplary method of the present invention is based on the idea on the one hand of protecting the soldering lands and the circuit traces attached thereto from being damaged by a press-fit pin that is not properly centered above the through hole and on the other hand to use the passage holes in the protective layer in order to direct the press-fit pins into the through holes of the printed circuit board or to center them in these through holes. In addition, the insulating protective layer prevents an unintentionally bent press-fit pin from contacting the soldering land of the press-fit socket and/or a circuit trace attached thereto such that the bent press-fit pin may be reliably detected in an electrical test without an additional visual inspection.

The desired results are achieved particularly well if the protective layer is made of a prepreg pressed onto the printed circuit board, that is, a prepolymerized glass hard fabric film impregnated by epoxy resin or vinyl ester, as is used, for example, for manufacturing multilayer printed circuit boards. The relatively high hardness of such prepreg films ensures on the one hand good protection of the soldering lands of the press-fit sockets or circuit traces that are covered by the film, and on the other hand has only a very low flexibility when a press-fit pin strikes it laterally such that the press-fit pin, without deforming the protective layer, can easily be deflected into the through hole of the printed circuit board and be “forcibly directed” in the process.

Alternatively, however, the protective layer may also be made of another electrically insulating material, for example, a plastic film laminated onto the printed circuit board, it covering, in accordance with another advantageous refinement of the exemplary embodiment and/or exemplary method of the present invention, annular soldering lands of the press-fit sockets as well as adjoining parts of circuit traces.

Expediently, the passage holes of the protective layer and the through holes of the press-fit sockets have round hole cross sections and are aligned with each other, that is, their center axes coincide. In order to achieve this, the passage holes may be expediently aligned in relation to the through holes in the printed circuit board with the aid of aligned positioning bore holes or with the aid of optical registers as are commonly used in the field of printed circuit board manufacturing.

Expediently, the passage holes of the protective layer have the same or slightly smaller diameters than the through holes of the press-fit sockets such that the protective layer covers the soldering lands completely even when the center axes of the passage holes of the protective layer and the through holes of the press-fit sockets differ slightly as a result of slight manufacturing tolerances when laminating or pressing on the protective layer.

Another exemplary embodiment of the present invention provides for the passage holes of the protective layer to taper in the direction of the printed circuit board, which may be a conical tapering, so as to direct press-fit pins having a lateral offset in relation to the center axis of the associated press-fit socket in the direction of latter's through hole when the tips of the press-fit pins strike the conical boundary walls of the passage opening when establishing the press-fit connection.

### BRIEF DESCRIPTION OF THE DRAWINGS

FIG. 1 shows a schematic top view onto a printed circuit board according to the exemplary embodiment and/or exemplary method of the present invention having two rows of press-fit sockets for press-fit pins of an electronic component.

FIG. 2 shows an enlarged sectional view along the line II-II of FIG. 1 when inserting press-fit pins having positional tolerances.

FIG. 3 shows a view corresponding to FIG. 2, but with a modification.

FIG. 4 shows a view corresponding to FIG. 2, but of a printed circuit board from the related art.

### DETAILED DESCRIPTION

The printed circuit board 2, shown in the drawing, of an airbag control unit of a motor vehicle supports in a known manner printed circuit traces on one or both broadsides as well as a number of electronic components (now shown), which are interconnected in a specified manner by the circuit traces on printed circuit board 2.

For manufacturing a solderless electrical connection to one of the electronic components, printed circuit board 2 is fitted, in proximity to one of its long side edges 4, 6, with two parallel rows of through contacts in the form of press-fit sockets 8, while the electronic component is fitted with a so-called multipoint plug, which comprises two parallel rows of press-fit pins 10, whose arrangement corresponds to the arrangement of the two rows of press-fit sockets 8 on printed circuit board 2. Press-fit pins 10 protruding from a housing of the electronic component respectively form a part of a punched bent part made of an electrically conductive material such as CuSn or CuNiSi, for example, which in the manufacture of the housing is expediently injected into the same or is shot into it following the injection molding process.

As shown best in FIG. 2, each of press-fit sockets 8 is made up of a hollow cylindrical jacket part 16 penetrating printed circuit board 2 between its two broadsides 12, 14, which surrounds a cylindrical through hole 18 used for accommodating a press-fit pin 10, as well as two annular soldering lands 20, 22 situated on the opposite end faces of press-fit socket 8 and connected in one piece to jacket part 16, which surround the ports of through hole 18 on all sides on the opposite broadsides 12, 14 of printed circuit board 2, which abut with their mutually facing annular shoulders 24, 26 respectively against the adjacent broadside 12 and 14 of printed circuit board 2, and which are used for electrically connecting one or more circuit traces (shown in FIGS. 2 through 4 for a circuit trace 28 on the upper side 12 of printed circuit board 2) to the respective press-fit socket 8.

As is also shown best in FIG. 2, press-fit pins 10 have a cylindrical shaft part 30, whose outer diameter is slightly greater than the inner diameter of through hole 18 of press-fit sockets 8 such that shaft part 30 of press-fit pin 10 is held with a press-fit in the associated press-fit socket 8 after the press-fit connection has been established with the aid of a suitable press-fit tool.

Since the positions of press-fit pins 10 in a plane that is parallel to broadsides 12, 14 of printed circuit board 2 are encumbered with more or less sizable manufacturing tolerances as a result of the injection of the punched bent parts, deviations may result between the center axes 32 of individual press-fit pins 10 and center axes 34 of the associated press-fit sockets 8 when mounting the multipoint plug-equipped electronic component on printed circuit board 2, as shown in FIGS. 2 and 4 on the basis of deviations of different magnitudes for a printed circuit board 2 according to the exemplary embodiment and/or exemplary method of the present invention and a printed circuit board 2 from the related art, respectively.

In the case of the printed circuit board 2 from the related art shown in FIG. 4, such deviations can result in problems. If there the deviation, as shown in the case of front press-fit pin 10, is smaller than the difference between the radius of through hole 18 and the radius of a front face 36 on the free end face of press-fit pin 10, then press-fit pin 10 does indeed slide into through hole 18, but when penetrating press-fit socket 8 it is “forcibly directed” by the latter, which can result in shavings or spangles being sheared off from press-fit pin 10 or from adjacent soldering land 20 or from jacket part 16 of press-fit socket 8 or in other one-sided damage of the same. If the deviation is greater than the difference between the radius of through hole 18 and the radius of front face 36, as shown for rear press-fit pin 10, the latter will strike with its front face 36 next to the port of through hole 18 onto soldering land 20 before either being deflected into through hole 18 or being bent away from through hole 18. In the first case, soldering land 20 and possibly jacket part 16 of press-fit socket 8 is damaged, while in the latter case, in addition to damage to soldering land 20, one or more circuit traces 28 on the upper side 12 of printed circuit board 2 may be damaged as well or a lose contact may result between bent press-fit pin 10 and the upper side of soldering land 20 or circuit trace 28 attached to it.

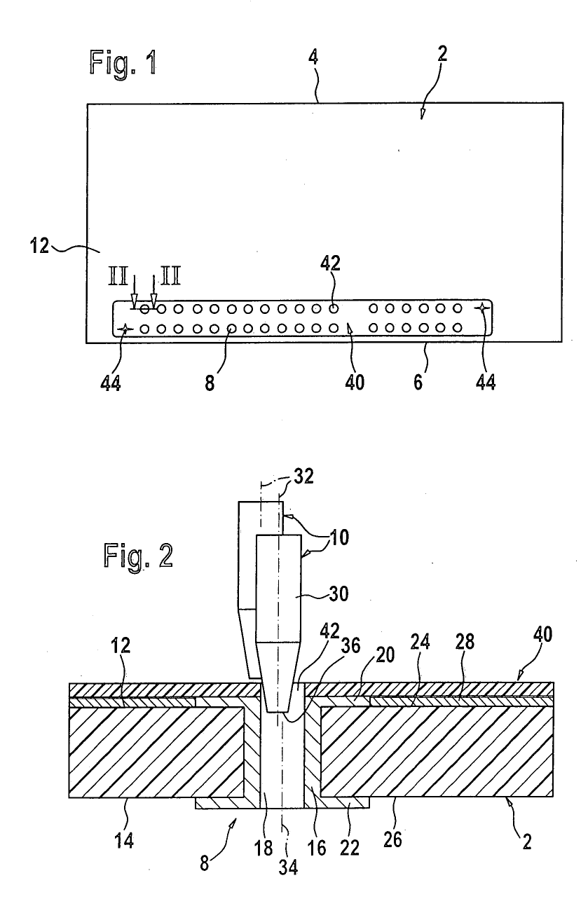

In order to avoid these problems, printed circuit board 2 of the exemplary embodiment and/or exemplary method of the present invention shown in FIGS. 1 and 2 has a protective film 40 made of an insulating plastic material, which is laminated onto upper side 12 of printed circuit board 2 in the region of the two rows of press-fit sockets 8 prior to pressing in press-fit pins 10. Prior to lamination, protective film 40 is provided with two rows of round passage holes 42, whose diameter and arrangement correspond to the diameter and arrangement of through holes 18 of the press-fit sockets, as shown in FIG. 2, such that protective film 40 completely covers soldering lands 20 and the adjoining parts of circuit traces 28, while passage holes 42 lie exactly above through holes 18 of press-fit sockets 8.

In order to ensure an exact alignment of passage holes 42 with through holes 18 of the press-fit pins when laminating protective film 40, both printed circuit board 2 and protective layer 40 have, beyond the end faces of the two rows of holes 18 and 42, two centering holes 44 situated identically with respect to holes 18, 42, through which in each case a centering pin extends when protective layer 40 is applied such that holes 18 and 42 come to lie congruently one upon the other.

The thickness of protective film 40 is less than the distance between the adjacent upper side 12 of printed circuit board 2 and a press-fit shoulder (not shown) provided on the housing of the electronic component or of the multipoint plug, which is to prevent press-fit pins 10 from being inserted too far into press-fit sockets 8.

Protective film 40 thus protects soldering lands 20 and circuit traces 28 from coming in contact with a tolerance-encumbered press-fit pin 10, which, depending on the magnitude of the deviation, is either deflected by protective layer 40 into its adjacent passage hole 42, as shown for front press-fit pin in FIG. 2, or is laterally bent away from passage hole 42, its front end face 36 gliding over protective layer 40 in the process. Protective layer 40 thus not only protects soldering land 20 and adjacent circuit traces 28 from being damaged by press-fit pin 10, but subsequently also prevents a loose contact between a bent press-fit pin 10 and soldering land 20 or circuit traces 28 such that defective press-fit pin 10 can be reliably detected in the electrical testing of the finished printed circuit board 2 that has been fitted with components.

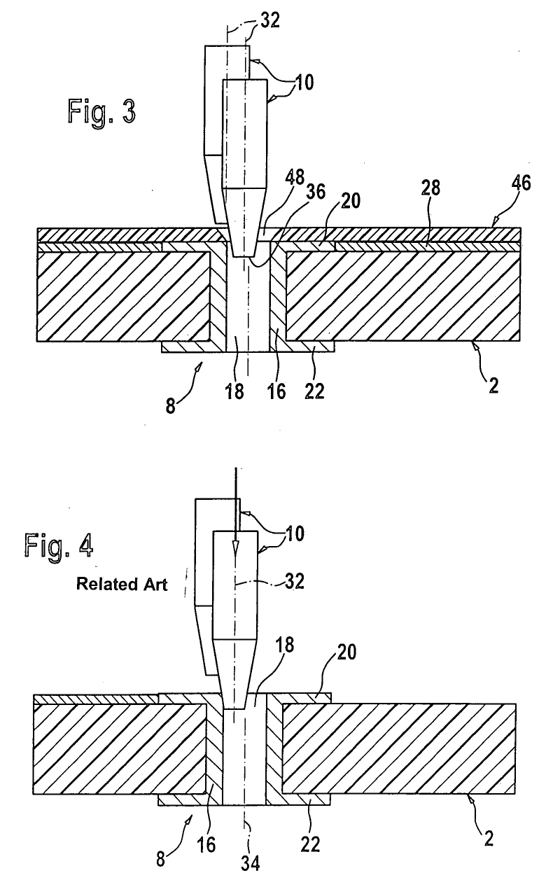

In the specific embodiment shown in FIG. 3, instead of a laminated protective film 40, printed circuit board 2 is provided with an FR4 prepreg film 46, made of an epoxy resin matrix having embedded continuous filaments, which is pressed onto upper side 12 of printed circuit board 2 around the two rows of press-fit sockets 8. In contrast to the specific embodiment from FIG. 2, film 46 moreover has passage holes 48 conically tapered in the direction of through holes 18 of press-fit sockets 8, which direct associated press-fit pins 10 better into through holes 18 of press-fit sockets 8 and thus allow for greater pin position tolerances.

As in the specific embodiment from FIG. 2, conical passage holes 48 may already be produced prior to pressing prepreg film 46 onto printed circuit board 2 and then be brought into congruence with through holes 18. Alternatively, however, it is also possible to produce passage holes 48 subsequently by drilling in prepreg film 46 pressed onto printed circuit board 2.

What is claimed is:

1. A printed circuit board comprising:
a plurality of press-fit sockets for accommodating press-fit pins, which are insertable from a direction of a broadside of the printed circuit board with press-fit into through holes of the press-fit sockets; and
an insulating protective layer, which is applied onto a section of the broadside of the printed circuit board, and which has passage holes for the press-fit pins situated above the through holes of the press-fit sockets.

2. The printed circuit board of claim 1, wherein the protective layer is made of a pressed-on prepreg film.

3. The printed circuit board of claim 1, wherein the protective layer is made of a laminated-on plastic film.

4. The printed circuit board of claim 1, wherein the protective layer covers annular soldering lands of the press-fit sockets.

5. The printed circuit board of claim 1, wherein the passage holes in the protective layer are aligned with the through holes of the press-fit sockets.

6. The printed circuit board of claim 1, wherein the passage holes in the protective layer have the same or slightly smaller cross-sectional dimensions than the through holes of the press-fit sockets.

7. The printed circuit board of claim 1, wherein the passage holes of the protective layer taper in a direction of the printed circuit board.

8. A method for manufacturing a solderless electrical connection between a printed circuit board fitted with press-fit sockets and a component fitted with press-fit pins, the method comprising:
applying a protective layer on a section of a broadside of the printed circuit board adjacent to the component, wherein there are passage holes for the press-fit pins situated above the through holes of the press-fit sockets; and
pressing the press-fit pins with press-fit into through holes of the press-fit sockets.

9. The method of claim 8, further comprising: wherein the protective layer is one of laminated and pressed on as a film, and prior to being laminated or pressed onto the printed circuit board, the passage holes are brought into congruence with the through holes when the protective layer is applied onto the printed circuit board.

10. The method of claim 9, wherein the passage holes are brought into congruence with aligned positioning holes in the protective layer and in the printed circuit board.

11. The method of claim 9, wherein the passage holes are brought into congruence with optical registers.

12. The method of claim 8, wherein the protective layer is one of laminated and pressed on as a film, and the passage holes are put into the protective layer after the protective layer has been applied onto the printed circuit board.
